(19) United States
(12) Patent Application Publication
(10) Pub. No.: US 2025/0132351 A1
(43) Pub. Date: Apr. 24, 2025

(54) Electrodes Comprising Covalently Joined Carbonaceous And Metalloid Powders And Methods Of Manufacturing Same

(71) Applicants: Yverick Pascal RANGOM, Waterloo (CA); Michael Allan POPE, Waterloo (CA)

(72) Inventors: Yverick Pascal RANGOM, Waterloo (CA); Michael Allan POPE, Waterloo (CA)

(21) Appl. No.: 18/695,322

(22) PCT Filed: Sep. 26, 2022
(86) PCT No.: PCT/CA2022/051418

§ 371 Date: Mar. 25, 2024

Related U.S. Application Data
(60) Provisional application No. 63/248,293, filed on Sep. 24, 2021.

(51) Int. Cl. H01M 4/66; H01M 4/04; H01M 4/62; H01M 10/0525; H01M 10/054

(52) U.S. Cl. CPC H01M 4/663; H01M 4/0404; H01M 4/0471; H01M 4/625; H01M 4/661; H01M 10/0525; H01M 10/054

(57) ABSTRACT

An electrode comprising covalently bonded interfaces between electrode active particles and between electro active particles and current collectors. In one aspect, the bonds comprise carbides or alloys. A method of forming such electrodes is also provided. Batteries and the like comprising the electrodes are also provided.

### CROSS REFERENCE TO PRIOR APPLICATIONS

The present application claims priority to U.S. Patent Application No. 63/248,293, filed Sep. 24, 2021. The entire contents of such prior application are incorporated herein by reference.

### FIELD OF THE DESCRIPTION

The present description is directed to the field of electrodes for use in energy storage systems, such as batteries, fuel cells, and the like. More particularly, the description relates to electrodes formed using unique methods of binding active materials and current collectors together, the compositions used therefor, and methods for forming such electrodes.

### BACKGROUND

The relatively high conductivity, low cost, abundance, low atomic mass, electrochemical stability and other favourable properties of carbonaceous materials (e.g., graphite, activated carbons, carbon blacks, graphene, carbon nanotubes, etc.) make them the material of choice for electrodes used as the active material directly, or as composites with or coatings on other active materials, in most electrochemical devices including batteries, supercapacitors and fuel cells. For example, silicon, a metalloid, is increasingly either composited with or coated with carbonaceous materials in order to improve electrode stability and conductivity. For all of these cases electrodes are usually comprised of a micron-sized powder which is cast dry or wet with other components onto a current collector foil (e.g., copper, aluminium) to create a thicker functional electrode film. Electrons flow between the current collector and the carbon and are transferred between hundreds to thousands of such packed particles throughout the film thickness. The flow of these electrons is often impeded by low contact area between particles and by the polymeric binders that are typically used to hold the particulate structure together. In some cases, these factors contribute to a significant resistance to electron flow, in particular, when electrodes are made in commercially relevant thicknesses (i.e., >10-100 μm thick). These thicker films are required to reduce the ratio of active material to inactive material in the electrochemical device. For example, in a lithium (Li) ion battery, any increase in electrode thickness leads to an improvement in energy density; however, such increased thickness typically comes at the expense of too high a resistance to operate the device at reasonable charge/discharge rates and thus, in practice, thicknesses are limited.

Li-ion batteries were invented in the 1970's and were commercialized in 1990's. Their relatively large energy density allowed them to be made light enough to usher the present era of portable electronics that includes cellphones, laptops and digital cameras. Despite the large success of these devices, under the worldwide environmental push for electrification of transportation the automotive sector has recently become the largest application for Li-ion batteries (Eftekhari A. et al.). However, mass adoption of electric vehicles (EVs) hinges on the ability of batteries to recharge in a timeframe comparable to the refuelling of internal combustion engine vehicles. By way of example, the U.S. Department of Energy has defined the Extreme Fast Charging (XFC) standards to require EVs to be able to reach 80% full charge in under 15 minutes (Liu, Y. et al.; Ahmed, S. et al.).

Such fast-charging is, however, hindered by the slow electrochemistry of Li-ion batteries, in particular at the anode where lithium plating and electrode delamination tend to occur under the large currents required under XFC conditions (Liu, Q. et al.; Prezas, P. D. et al.). These phenomena are caused by the local potential dropping below 0 V vs. Li/Li⁺ and joule heating, respectively. Both causes are the result of high electrode ionic and electronic impedance. One of the main causes of ionic impedance of anodes is related to charge transport through the solid electrolyte interphase (SEI) that is formed (Rangom, Y. et al., 2021).

As is known in the art, the so-called formation cycle is important in creating a stable SEI on a graphite anode, and such process is typically carried out at C/10, in other words, one full charge over 10 hours of charging time, at the manufacturing facility. This therefore means that every battery must be hooked up to a charger for over 10 h after packaging, which adds significant costs to the manufacturing process. Currently, the cost of the SEI formation step is estimated at around 6% of total battery production costs. It has recently been shown that SEI formation at high rates can better facilitate fast charging but only in thin films due to the limited conductivity of thicker graphite anodes.

Readily available fast-charging batteries that are able to satisfy XFC requirements utilize lithium titanium oxide (LTO). LTO chemistry exhibits fast lithium storage kinetics at a relatively high voltage between 1.5 and 1.6 V vs. Li/Li⁺ that prevents SEI formation. However, the reduced cell voltage also reduces energy density by at least 33% compared to a graphite anode. Furthermore, LTO's specific capacity of 175 mAh/g is less than half that of graphite making such anode material less than ideal for EV applications. A more rational approach to fast charging involves heating batteries before charging. In this regard, it has been demonstrated that elevating temperatures from 25 to 45° C. increases electrolyte conductivity by a factor of 1.4 and intercalation kinetics by 5.6 (Yang, et al.). However, high temperatures can degrade electrolytes and accelerate aging (Hou, et al.). Furthermore, EV batteries can exceed half a ton in weight which requires a significant amount of time to achieve the desired heating, especially in cold climates. Therefore, an alternative method for achieving fast charging is necessary.

It has been known that forming SEI layers under high current rates significantly increases their conductivity. A thin film study recently published demonstrates that stable SEI layers can be formed under high current rates if the electrode electronic impedance is decreased.

Traditional slurries can support charge and discharge rates well above those required for XFC, however this requires unpractical amounts of carbon conductive additive, such as up to 65% (Kang, et al.).

There is, therefore, a need for an improvement in the known electrodes and/or active materials used for forming electrodes, particularly those for use in Li-ion batteries.

### SUMMARY OF THE DESCRIPTION

In one aspect, the present description provides novel electrodes, such as electrodes used in lithium (Li) ion batteries, and electroactive materials therefor. In one aspect, the description provides an electrode architecture wherein active materials are bound to current collectors with electrically conductive, covalently bonded interfaces. Such architecture results in increased electronic conductivity as well as improved bonding strength between the active material and the current collector.

The description also provides a method for increasing electronic conductivity as well as bonding strength between the electroactive materials and the current collector of an electrode. The method comprises the formation of functional covalent bonds between heterogeneous materials including carbonaceous, metallic, and metalloid materials. The method and resulting compositions described herein address one or more of the deficiencies known in the art.

### BRIEF DESCRIPTION OF THE FIGURES

The features of certain embodiments will become more apparent in the following detailed description in which reference is made to the appended figures wherein:

FIG. 1a schematically illustrates known non-bonded architecture between active materials and current collectors.

FIG. 1b schematically illustrates bonding between active materials and current collectors according to an aspect of the present description.

FIG. 2 is a schematic representation of Swagelok three-electrode half-cell.

FIG. 3a schematically illustrates a covalently joined electrode architecture with carbide or metal alloy interfaces.

FIG. 3b schematically illustrates carbide or intermetallic interfaces between active material particles (upper figure) and traditional architecture with non-bonded conductive additive (bottom figure).

FIG. 3c schematically illustrates the same system shown in FIG. 3b but with SEI layer grown on the surface of the systems.

FIG. 4a is a scanning electron microscope (SEM) image of mesocarbon microbeads (MCMB) graphite particles with TiC bond.

FIG. 4b illustrates a mapping of carbon, C, and titanium, T, by energy-dispersive X-ray spectroscopy of the SEM capture of FIG. 4a.

FIG. 4c is a SEM image of mesocarbon microbeads (MCMB) graphite particles.

FIG. 4d is a SEM image of titanium hydride nanoparticles.

FIG. 5a illustrates X-ray diffraction (XRD) characterisation of Ketjenblack™-TiH₂ powder mixture sintered at different temperatures (1000° C. (a), 800° C. (b), 600° C. (c), and 400° C. (d)) under argon under 31 MPa of pressure.

FIG. 5b illustrates XRD characterisation of (I) graphite powder, (II) titanium carbide powder, and (III) a mixture of graphite and titanium hydride, sintered at 1000° C. under argon.

FIGS. 6a and 6b schematically illustrate the pellet pressing of MCMB graphite and TiH₂ particles, where FIG. 6a illustrates cold pressing at room temperature, and FIG. 6b illustrates hot pressing at 1000° C. under argon.

FIG. 7a illustrates electrochemical impedance spectroscopy (EIS) characterisation of carbon-TiH₂ electrode pellets sintered at 900° C. with a separate copper current collector, with a separate gold coated copper current collector, and with a copper current collector sintered at 900° C. along with the pellet electrode.

FIG. 7b illustrates galvanostatic cycling of covalently joined (upper curve) and commercially available slurry (lower curve) architectures at 4C lithiation and 1C delithiation from 0.01 to 2.00 V vs. Li/Li+.

FIG. 8 illustrates the thermogravimetric analysis (TGA) of polyvinyl alcohol (PVA) binder under nitrogen with photographs of the material before sintering (top left) and after sintering (bottom right).

FIG. 9 illustrates the galvanostatic cycling of covalently-joined lithium iron phosphate (LFP) (upper lines) and reference slurry (lower lines) electrodes at different current densities 1C-4C-10C-40C-100C from 2.0 to 4.2 V vs. Li/Li+.

FIG. 10a illustrates XRD characterisation of (I) silicon, (II) TiH₂, and (III) Ti—Si alloy.

FIG. 10b illustrates galvanostatic cycling of covalently-joined silicon electrode at diverse current density 0.1C-0.5C-1C-0.1C from 0.01 to 2.00 V vs. Li/Li+.

### DETAILED DESCRIPTION

Described herein are novel methods and compositions of electrode architecture that bind active material and a current collector together using electrically conductive, covalently bonded interfaces. Also described herein are methods for the production of such material. The compositions described herein have utility in the field of electrodes for use in energy storage systems and related applications including batteries, fuel cells, and the like.

In general, the present description provides a method of covalently bonding active material of an electrode to a heterogeneous current collector either directly or through an intermediate active compound. Covalent bonding can be achieved directly with a metal or metal-plated current collector such as, but not limited to nickel, titanium, vanadium, chromium, tungsten, tantalum, molybdenum, niobium, hafnium, zirconium, boron, silicon, germanium, antimony, tellurium, arsenic, polonium and astatine and their compounds. The chemical bonding between current collectors and any combination of carbons or metalloids particle or coating or composites of these materials can also be achieved through an intermediate active compound of any the aforementioned elements.

The description also provides a method of forming covalent bonds between the carbonaceous or carbon coated, metalloid particles constituent of electrodes. These bonds can be achieved by incorporating the elements and compounds mentioned above in the composition of electrode materials.

In one aspect, the new architecture described herein uses an additive, such as titanium hydride, to produce carbide bonds with carbon-based or carbon-coated materials. Furthermore, the same system alloys with metalloids and metal current collectors when sintered at high temperatures, such as greater than about 400° C., under inert atmosphere. The sintering temperature may be from about 400° C. to about 1000° C., including 400° C., 500° C., 600° C., 700° C., 800° C., 900° C., and 1000° C., any temperatures there-between. Preferably, the sintering step is conducted at a temperature from about 600° C. to about 1000° C. A covalently joined electrode architecture as described herein avoids the need for a polymeric binder as typically used in the art or can transform it into conductive carbonized material.

As discussed further below, another feature realized by the method of the present description relates to the decomposition of the polymers used to form the slurry comprising active electrode components. Specifically, in order to form the electrodes described herein, the desired active particles are dispersed in a polymer and subsequently applied to a current collector. Typically, after drying, such polymers are retained in the active material matrix. However, with the method described herein, the formed electrode is subjected to a heating phase, which results in decomposition of the polymer material in a gaseous phase. Consequently, the electrode is provided with a degree of porosity, which was not realizable with known methods and results in improved ionic pathways throughout the electrodes.

The present description provides a unique method for covalently linking or fusing carbon particles together with carbide-based interconnects. This both mechanically and electrically crosslinks the particle constituents of the electrode, significantly improving conductivity and eliminating the need for polymer binders. In one aspect, this is achieved by mixing a carbide or alloy forming additive, such as TiH₂, with a carbon-based active material (and optionally with a sacrificial carbon source, such as a conductive carbon additive) which are cast together using conventional electrode casting methods (e.g., slurry casting). The electrodes are heated to induce a carbothermal reaction which converts the carbon and TiH₂ to a covalent composite of carbon and titanium carbide, TiC.

Furthermore, as known in the art, a significant resistance in an electrode is attributed to the contact between the current collector and the carbon particles. Using a carbothermal reaction as discussed herein, it is possible to covalently join these two interfaces with conductive covalent bonds.

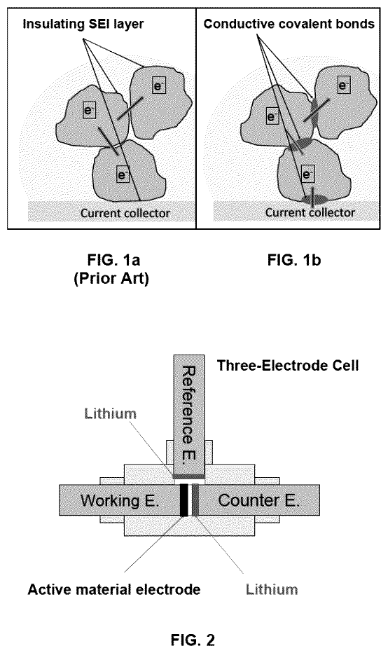

FIG. 1a illustrates a prior art electrode architecture, whereas FIG. 1b illustrates an architecture according to an aspect of the description, wherein the conductive covalent bonds 6 are shown.

In one example, the present inventors found that a graphite-based anode and a carbon-coated lithium iron phosphate cathode with covalent, conductive bonds, as described herein, cycled at 4C at room temperature delivered up to 80% of the capacity that can be achieved at low rates. In contrast, the corresponding traditional slurry-based anode and cathode delivered about 20% and 60% of the capacity achievable at lower rates, respectively, when cycled at the same 4C rate and temperature.

As would be understood by persons skilled in the art, the term “C” value refers to charging rate of a battery and, more particularly, the rate at which the battery can be charged to its nominal or theoretical capacity in 1 hour. Thus, a battery charged at a rate of 0.1C capacity requires 10 hours, and a battery charged at a rate of 2C will charge for 30 minutes. Therefore, to meet the above mentioned XFC standard, a battery is expected to charge at a minimum of 3.2C rate and be able to charge to 80% of the nominal or theoretical capacity during this timeframe (i.e., 15 min or less).

### Active Materials

The present description provides certain examples of active materials that may be used to form the electrodes described herein. Such examples are provided to illustrate the features of the invention and are not intended to limit the scope of same. The description contemplates the use of other active materials, such as one or more of:
a) carbonaceous materials, including but not limited to graphite, hard carbons (i.e., carbons that are not graphitizable), soft carbons (i.e., carbons that are graphitizable), advanced carbon materials (such as carbon nanotubes, graphene, and fullerenes), activated carbons, carbon blacks (such as, for example, Ketjenblack™), carbon papers, carbon fibers, carbon felts, and mixtures thereof;
b) carbon coated or carbon composited metalloids, including but not limited to carbon-coated lithium iron phosphate, carbon coated silicon, carbon coated silicon oxide, carbon coated germanium, carbon coated germanium oxide, carbon coated antimony, carbon coated antimony oxide, carbon coated tin, carbon coated tin oxide, carbon coated zinc, carbon coated zinc oxide, carbon coated sulfur, carbon coated sulfur oxide, and mixtures thereof;
c) metalloid materials, including but not limited to silicon, germanium, antimony, tin, zinc, sulfur, any compounds or oxides thereof, and any mixtures thereof;
d) transition metal oxides, including and not limited to titanium oxide, manganese oxide, cobalt oxide, iron oxide, nickel oxide, and any mixtures thereof; and,
e) transition metal carbides and nitrides, in particular MXenes, including but not limited to titanium carbide MXene (Ti₃C₂Tₓ), and selenides (such as, CoSe, FeSe₂, and NiSe₂), and any mixtures thereof.

### Additive Materials

As noted above, the description comprises the use of additive materials for forming carbide bonds or alloys between electrode active materials and current collectors and/or between particles of active materials. The description contemplates the use of any carbide forming or alloy forming compounds, such as compounds of transition metal and metalloid elements. Such additive materials include, but are not limited to compounds of titanium, vanadium, tungsten, zirconium, molybdenum, niobium, silicon, or germanium, and mixtures thereof. In one aspect, the description provides the use of titanium hydride as an additive for the formation of such carbide bonds. However, the description also contemplates the use of other titanium compounds as would be known to persons skilled in the art.

### Electrode Preparation

In one aspect, the present description provides electrodes having a unique architecture, wherein electrode active materials are covalently bonded to current collector materials. Methods of manufacturing such electrodes are also described.

Covalently joined electrode architectures as described herein were prepared by sintering traditional electrode slurry components comprising active materials in combination with a carbide forming additive, as described herein. In one example, the additive comprised titanium hydride (TiH₂) nanoparticles (such as available from Nanoshell). The active materials were mixed with the additive, in this instance titanium hydride nanoparticles. Typically, the amount of active material ranges between 80 and 90% by weight and concentration of the additive, such as TiH₂ nanoparticles, may range from 5 to 10 wt %.

As known in the art, one or more other conductive carbon additives may be included along with the active materials and carbide or alloy forming additives.

In one aspect, and particularly where carbonaceous active materials are incorporated, the additive particles, e.g., TiH₂ nanoparticles, may be subjected to an optional “activation” step before being combined with the active materials. In such optional step, the additive particles are combined with a small quantity of the corresponding active material particles and subjected to a ball milling step. Ideally, the activation, or ball milling step is performed under inert atmosphere (e.g., an argon atmosphere). Generally, the inert atmosphere is one that is absent of oxygen or nitrogen. In one aspect, the weight ratio of the additive material to carbonaceous material for the activation step may preferably be 2 to 1; however, other ratios are possible, such as 1:1, 3:1, 4:1, 5:1 or greater. In one example, the milling parameters utilized were 400 rpm for 3 hours with a ball to powder weight ratio of 20 to 1. In the present example, where carbon-coated materials were used, the activation step was conducted with a further carbon conductive additive, such as Super P™.

Without being held to any theory, it is believed that the aforementioned activation step initiates bond formation or initiation sites between the additive particles and the particles of carbonaceous material. This activation procedure is preferred as it reduces the temperature needed for the subsequent formation of carbide covalent bonding.

The above-mentioned activation step may not be necessary for active materials comprising metalloids.

For anode materials, the aforementioned powders were mixed and added to an aqueous solution of polyacrylic acid (PAA) or polyvinyl alcohol (PVA) or any mixture thereof. Thus, the weight ratio of PAA relative to PVA may vary from 100:0, 90:1, 80:20, 70:30, 60:40, 50:50, 40:60, 30:70, 20:80, 10:90, and 0:100, or any value there-between.

For cathode materials, an organic solution of PAA dispersed in N-methyl-2-pyrrolidine (NMP) may also be used. As would be understood by persons skilled in the art, most cathode materials react with water and, as such, non-aqueous polymers would be preferred.

Dispersions of powders and dissolved polymers were subsequently homogenized using a high-sheer homogenizer for a few minutes. The dispersion was then cast onto a titanium, copper, titanium-coated copper, and aluminum current collector foils using a doctor blade applicator. The electrodes were left to dry in an oven at 75° C. (aqueous) or 150° C. (organic) overnight.

The dried electrodes were then calendared. Such calendaring may be conducted under pressure, such as a pressure of about 77.4 MPa, as a pressing step. The calendared electrodes were then sintered at temperatures greater than 400° C., The sintering may be conducted at a temperature from about 400° C. to about 1000° C., and preferably from about 600° C. to about 1000° C. Ideally, the sintering is conducted under inert atmosphere, such as under argon. Furnace settings were 10° C./min ramp and retained at the final temperature for a minimum of 15 minutes. Further examples of the electrode manufacturing method are provided below. The sintering step may optionally be conducted under pressure.

### Illustration of Architecture

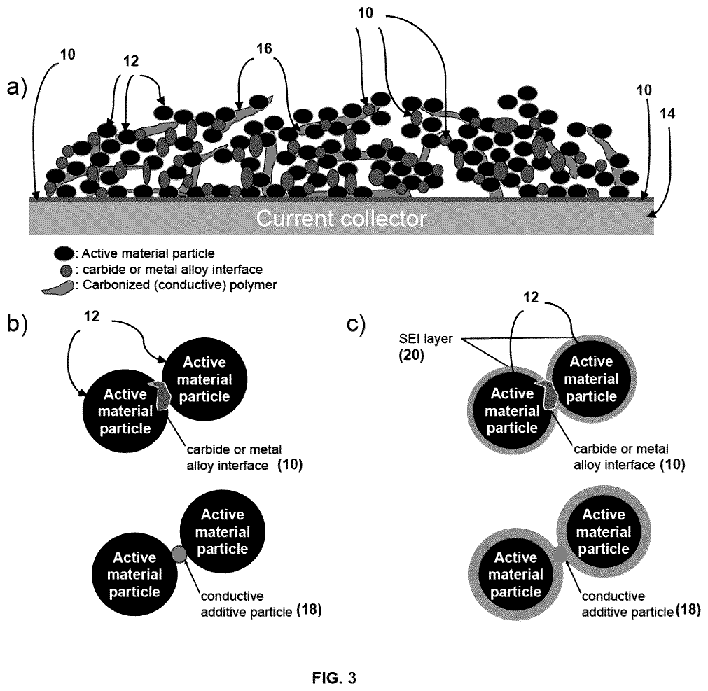

The covalently joined architecture described herein comprises conductive covalently bonded interfaces 10 between conductive active material particles 12 and the current collector 14, preferably a metal current collector as illustrated in FIG. 3a. These conductive interfaces can be carbides in the case of carbon active materials, or intermetallic alloys in the case of metalloids such as silicon. FIG. 3a further illustrates a carbonized (conductive) polymer, shown at 16 that may optionally be included.

The top schematic in FIG. 3b depicts the carbide or intermetallic alloy forming the covalently bonded interface 10 joining conductive active material particles 12 that reacted with additives such as titanium hydride nanoparticles. For comparison, the bottom schematic in FIG. 3b depicts the traditional architecture with the same active material particles connected by a non-bonded conductive additive particle 18, when provided.

FIG. 3c depicts the same systems as in FIG. 3b but with an SEI layer 20 grown on the surfaces of the active material particles 12. As seen in the upper schematic of FIG. 3b, the electrical connection between particles remains unaffected. In contrast, and as illustrated in FIG. 3b, the traditional system risks progressive electrical disconnection as the SEI layer 20 grows and interferes with the contact between the active material particles and the conductive additive particles 18. In particular, in a system joined by permanent covalently bonds between particles such as described herein, SEI growth is prevented from developing between active particles, thereby mitigating the possibility of losing electrical contact there-between.

In the upper illustration of FIG. 3c, the SEI layer 20 on the covalently joined particles of the present system is represented as being thinner than in the traditional system (shown in the bottom illustration of FIG. 3c) in order to illustrate that, with the electrodes described herein, it is possible to form such layer under higher current densities in a more electrically conductive system whereby such layer is formed in thinner configuration.

### Characterization

In the present study, thermogravimetric analyses (TGA) were conducted on a TA Instrument TGA Q500™ in nitrogen with a heating rate of 10° C./min. The morphology of graphite particles and electrodes was imaged on Zeiss LEO™ field-emission scanning electron microscope (FE-SEM) under a beam acceleration of 4 kV. Energy-dispersive X-ray spectroscopy (EDS) was conducted on the same FE-SEM machine under 20 kV beam acceleration. X-ray diffraction (XRD) patterns were collected on a Rigaku MiniFlex II™ desktop X-ray diffractometer with copper radiation.

### Electrochemical Methods

The sintered electrodes were tested in three-electrode Swagelok™ cells as shown in FIG. 2. Half-cells were produced by cycling electrodes against lithium metal foils as counter and reference electrodes, respectively (FIG. 2). Full cells were produced by pairing anode against cathode with a lithium metal foil as reference electrode. Cells were assembled in an argon-filled glove box. Celgard™ and Whatman™ glass fibre filters were used as separators. The electrolyte was a one molar (1 M) solution of lithium hexafluorophosphate salt (LiPF₆) dissolved in a mixture of ethylene carbonate (EC) and dimethyl carbonate (DMC) with an equal volume ratio (1:1). All electrochemical characterisations were conducted using Biologic™ potentiostats (SP-200 and VSP). Galvanostatic charge/discharge cycling tests were carried out in the potential range between 0.01 and 2.00 V vs. Li/Li+ for anode half cells, and from 2.00 to 4.20 V vs. Li/Li+ for cathode half cells. SEI layers were formed on graphite anodes with a current density of 333 mA/g (or 1C). Cycling tests were conducted at 1C, 4C for graphite anode materials and 1C, 4C 100, 40C and 100C for carbon-coated lithium iron phosphate (C-LFP) cathodes where 1C corresponds to 155 mA/g. These cycling tests were conducted at identical charge and discharge currents.

### Examples

### Graphite Anodes for Li-Ion Batteries (Directly Generalizable to all Carbon Anodes for all Alkali-Ion Batteries)

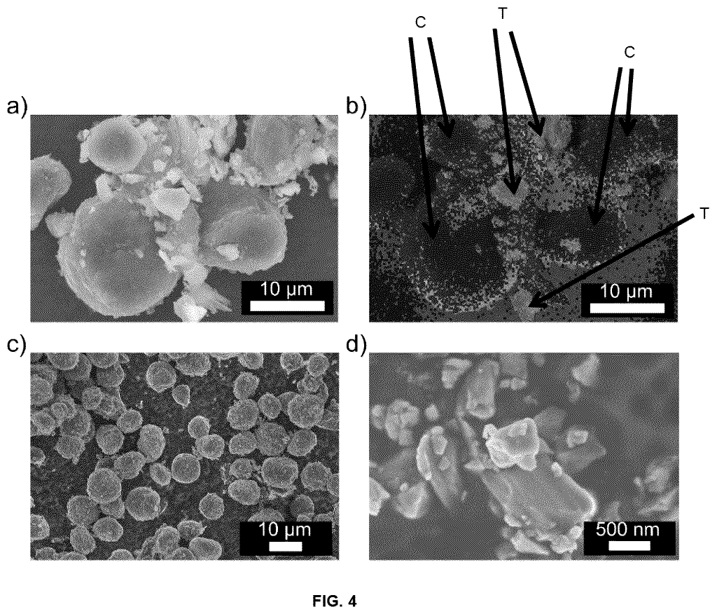

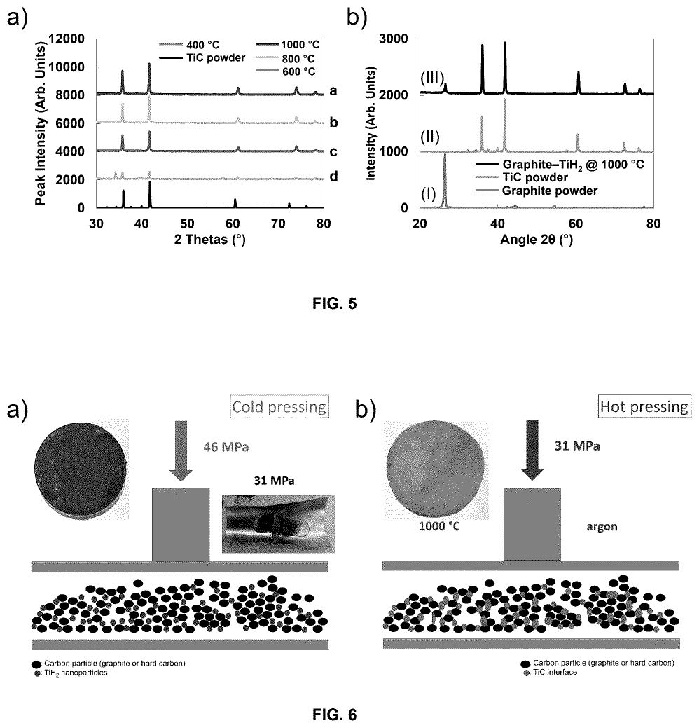

FIG. 4a shows scanning electron microscope, SEM, images of mesocarbon microbeads (MCMB) graphite particles with titanium carbide grown in-between. Pristine MCMB particles are spherical and the TiH₂ particles have angular shapes (see FIG. 4c and FIG. 4d, respectively). FIGS. 4a-d show that both MCMB particles and titanium compound retain their original morphologies after sintering as both particle types remain clearly identifiable. EDS mapping illustrated in FIG. 4b confirms the chemical composition of the spherical shapes as carbon. From FIG. 4b, it is also clear that carbon has migrated into the titanium compound while the titanium remains in place to create the TIC intermediate particle as per the XRD characterisation data presented in FIGS. 5a and 5b.

For carbons, the reaction between TiH₂ and carbon particles is obtained after ball milling activation of TiH₂ particles and by sintering under argon at temperatures over 400° C. as shown in FIG. 5a. The mixtures of Ketjenblack™ and TiH₂ particles sintered at different temperatures were identical to a 4:1 mixture by weight of Ketjenblack™ to TiH₂ particles respectively. The mixtures were sintered in a hot press under 31 MPa of pressure. The resulting pellets were crushed and characterized by XRD. In FIG. 5b, the graphite-TiH₂ mixture sintered at 1000° C. presented characteristic peaks from both the graphite and titanium carbide compounds. Combined with the SEM and EDS data presented in FIG. 4, the XRD data indicates that the intended particle-to-particle covalent bonding was produced.

In addition, a crush test was conducted on both the compacted non-sintered and sintered graphite-TiH₂ powder pellet, as illustrated in FIGS. 6a and 6b. The cold pressed pellet did not have any TiC content and was crushed under a pressure of 0.24 MPa, while the pellet hot pressed at 1000° C. with formation of TiC withstood a pressure over one order of magnitude higher (9.47 MPa). This increase in mechanical properties is indicative of the formation of a network of covalently joined particles. As shown in FIG. 6b, the hot-pressed pellet was obtained at a pressure of 31 MPa and a temperature of 1000° C. under argon atmosphere. It was not possible to produce a self standing pellet by cold pressing under 31 MPa as shown in FIG. 6a, therefore a higher pressure of 46 MPa was applied for the cold pressing step.

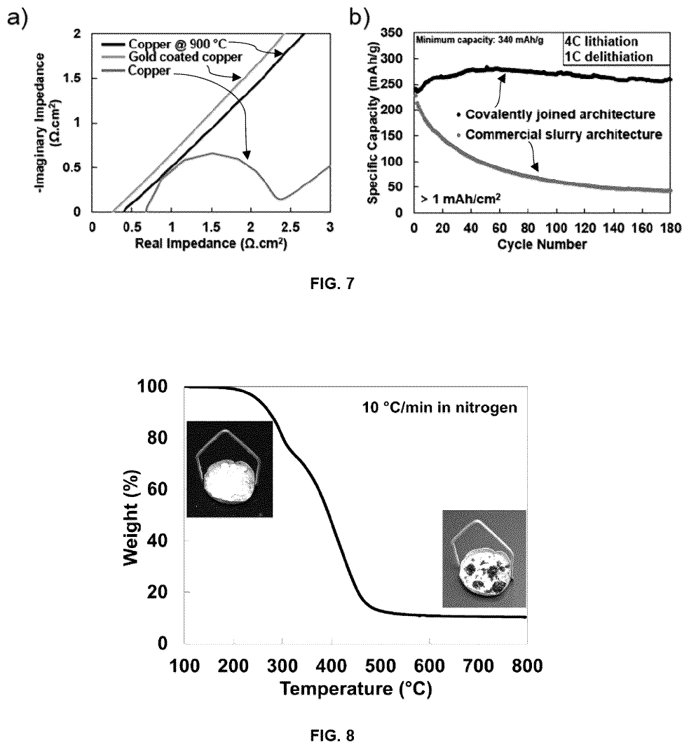

The covalent bond between the active material particles and the current collector is shown indirectly via electrochemical impedance spectroscopy (EIS) characterisation. As illustrated in FIG. 7a, the cells with gold coated and sintered copper current collector do not present a semi-circle like the cell with a non-sintered current collector. It is known that such semi-circular curve indicates the presence of a resistive electronic interface that disappears after sintering. It was concluded that covalent bonds by alloying of titanium and copper has occurred. When a titanium current collector is used with carbon electrode, TiC bonding with the current collector is directly proved via XRD characterisation.

Thus, as shown by the present results, mitigating electronic impedance at both the current collector particle and particle-to-particle interfaces, as made possible by the present description, allows for improved cycling at fast rates.

The composition of the electrodes featured in FIG. 6b will now be discussed. The reference slurry electrode was 80 wt % graphite, 10 wt % Super P™ carbon additive, 5 wt % Na-CMC (sodium carboxymethyl cellulose), with a mass loading 1.72 mg/cm². The covalently joined electrode is 90 wt % graphite, 5 wt % TiH₂, 5 wt % Na-CMC before sintering, with a mass loading of 2.18 mg/cm². After sintering, Na-CMC is reported to lose 61.4% of its weight after sintering under protective atmosphere (Yan, et al.). The remaining by-product of sintering Na-CMC is 42 wt % carbon and 58 wt % sodium carbonate (Na₂CO₃). While the Na₂CO₃ residue stays inert in the battery, it is dead weight. Therefore, Na-CMC can preferably be replaced by PAA which leaves 10 wt % carbon after sintering as characterized by thermogravimetric analysis (TGA) (FIG. 8) or PVA that leaves no residue at all or a combination of these binders.

In FIG. 7b, the capacity retention of a covalently joined graphite anode is compared to that of a commercial slurry-based electrode purchased from NEI Corporation. The commercially obtained electrode comprised the same graphite particles. The covalently joined electrode displayed a capacity up to 80% of capacity of the minimal capacity of the graphite material. Over 180 cycles, the capacity of the covalently joined architecture described herein was found to stay nearly flat, while the commercial cell experienced catastrophic decay. One of the reasons for the better performance of the cell of the present description can be attributed to the higher electronic conductivity of the covalently joined architecture, which allows for performing the complete SEI formation step at a current density of 4C, while the commercial cell can only form a partial SEI at that rate (Rangom, Y., et al. (2021); Rangom, Y., et al. (2019).) Thus, the SEI formed at 4C was found to have lower ionic impedance than if it was formed at the traditional 0.1C current rate. The lower electronic and ionic conductivity combined allow for the better performance especially at high C rates.

### 2) Carbon-Coated Lithium Iron Phosphate Cathode for Li-Ion Batteries (Directly Generalizable to all Carbon-Coated Materials for Alkali-Ion Batteries)

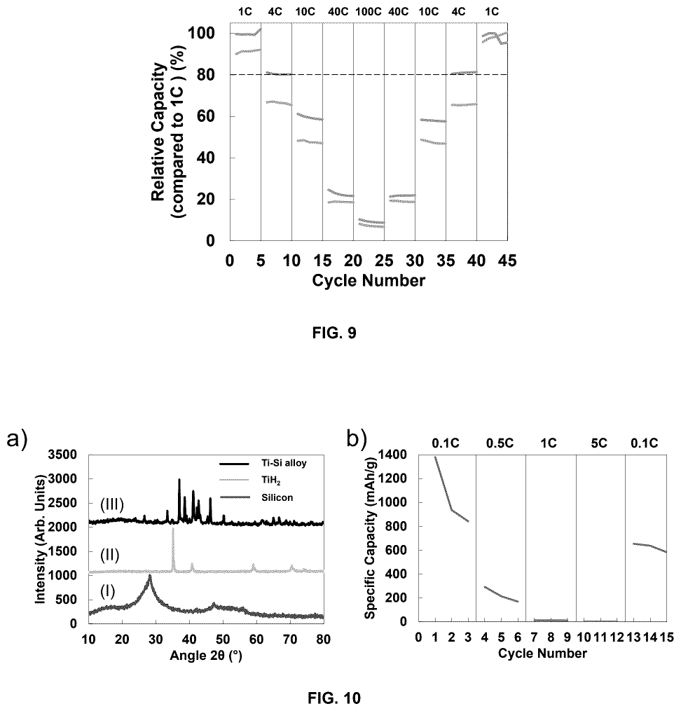

Similarly, to pure carbon active material, carbon coated materials can also be incorporated in covalent joined architecture sintered with TiH₂ additive. For C-LFP (lithium iron phosphate) cathode material, an increase of about 28% in electrochemical performance at 4C is measured compared to traditional slurry as shown in FIG. 9.

### 3) Silicon Anode for Li-Ion Batteries (Directly Generalizable to all Metalloid Materials for Alkali-Ion Batteries)

Silicon anode material also alloys with titanium from TiH₂ particles and copper current collector through sintering under protective atmosphere (FIG. 10a), thus creating a covalently joined electrode that was cycled from 0.1C to 5C (FIG. 10b). 1C corresponds to the theoretical capacity of silicon (3579 mA/g). The second cycle at 0.1C returns a capacity of 935 mAh/g that is consistent with known Ti—Si alloy anodes.

Silicon nanoparticles and TiH₂ particles were tested as reference powders. A 2:1 mixture of TiH₂ and silicon powder respectively was hot pressed at 1000° C. under 31 MPa of pressure in argon atmosphere. The XRD characterisation of the sintered powder showed a complete reaction as the original peaks for silicon and TiH₂ have disappeared.

### CONCLUSIONS

One objective of the present study was to provide a battery that is able to achieve extreme fast charging (XFC) as defined by the US department of energy, namely, reaching at least 80% state-of-charge in 15 minutes. As discussed above, prior to the present description, a number of hurdles were known to achieving such goal, where such hurdles were mainly associated with the rapid transport of both electrons and ions through the different interfaces of thick high-energy electrodes. The covalently bonded architecture described herein, featuring electrically conductive particle-to-particle and collector-to-particles bonds, has been found to achieve XFC and thereby to reduce battery production times.

The presently described covalently bonded carbon-carbide architecture allows the use of conventional materials such as graphite and carbon coated cathode materials along with known electrolytes to be charged and discharged under higher current densities in order to achieve the XFC charging standard. Previously known techniques required the use of either exotic materials or unconventional electrolytes with a narrower electrochemical stability window (ESW) that can only offer lower energy storage battery compared to traditional materials and electrolytes.

The described chemically bonded electrode architectures offer simultaneous optimization of transport of both ions and electrons in the bulk of electrodes, through electrically conductive bonds and through tuned porosity, as well as low-impedance SEI layers formed under high current densities. These advantages are obtained with the materials discussed above and an additional heat-treatment step in the battery manufacturing workflow.

The description also shows that the enhanced conductivity of electrodes created by the method described herein enables the formation of stable SEI at fast rates. When SEI is formed at 10C, which corresponds to a cycle rate of 6 min, i.e., one hundred times faster than traditional 0.1C (or C/10) current rate, electrodes only display a slightly lower efficiency for a few tens of cycles and then become as stable as cells worked in at the traditional 0.1C rate. The ability to form SEI layers at 1C that is over an order of magnitude higher current density compared to regular practice of 0.1C or lower produces a SEI layer with lower impedance and reduces the overall formation time during battery manufacturing.

Thus, as discussed herein, the architecture described above offers one or more of the following advantages:

1) The covalently bonded architecture described herein reduces potential gradients throughout the bulk of the electrode and increases the electric field between the cathode and anode. This is achieved by reducing the impedance with improved and permanent electronic connectivity between particles and current collector of each electrode. Thus, a constant electric potential is established throughout the bulk of the electrode, whereby a more uniform and higher electric field is established between carbide-bonded electrode and counter electrode.

2) Improved ionic conductivity of the SEI layers, which is enabled by forming such layers under high current densities, such as in the hundreds and thousands of mA/g based on mass of active material.

3) Improved ionic pathways throughout the electrodes, which is achieved by engineering additional porosity in the electrode bulk through evaporation or decomposition of compounds such as polyvinyl alcohol (or others) during a heat-treatment step. This features thereby results in faster transport of ions through the electrodes.

4) Mitigation or prevention of electrode delamination, which is achieved as a result of the electrically conductive chemical bonds that are formed between the active material and the current collector.

5) The ability to form SEI layers under high current rates, which significantly reduces the time to for SEI formation as compared to current methods where SEI layers are formed under typically low current density.

As will be appreciated from the foregoing, the methods and materials described herein have applications in the development of fast charging Li-ion batteries or in alkali-ion batteries. It will also be appreciated that the described materials and methods also have applications in high-loading supercapacitors. As known in the art, high surface area activated carbons or carbon black electrodes are used in commercial supercapacitors which require thick >100 μm electrodes to increase energy density but usually at the expense of power density. We have demonstrated the utility of the presently described materials by fabricating thick electrodes using Ketjenblack™, “KB” (an activated carbon black) that has utility as a supercapacitor electrode. By comparing the same electrodes prepared by casting with TiH₂ and heat treatment with those simply bound with conventional binder, we observed a significant boost in high-rate performance for the covalent KB/TiC composite electrode.

It will be appreciated that the above-mentioned examples are provided only to illustrate embodiments and aspects of the methods and materials described herein. Accordingly various other uses of such methods and materials will be apparent to those skilled in the art having read the present description. Such other uses may involve, for example, carbonaceous materials and electrochemical devices that would benefit from the features described herein, such as the lower resistance of carbon-TiC-carbon covalent interfaces over carbon-carbon van der Waals contacts. In addition to electrochemical devices, the methods and materials described herein could be used to covalently join discretely tiled graphene sheets for transparent conductors or used in thin or thick carbon films to create conductive foils (for example, a more conductive version of Graphoil™), etc. for electrical contacting or electromagnetic interference shielding, etc.

Although the above description includes reference to certain specific embodiments, various modifications thereof will be apparent to those skilled in the art. Any examples provided herein are included solely for the purpose of illustration and are not intended to be limiting in any way. Any drawings provided herein are solely for the purpose of illustrating various aspects of the description and are not intended to be drawn to scale or to be limiting in any way. The scope of the claims appended hereto should not be limited by the preferred embodiments set forth in the above description but should be given the broadest interpretation consistent with the present specification as a whole. The disclosures of all prior art recited herein are incorporated herein by reference in their entirety.

### References

BE U.S. Pat. No. 819,672.
U.S. Pat. No. 4,302,518.
JP Patent No. 1989293.
CN Patent Application No. CN113735127.
Yoshino, A., The birth of the lithium-ion battery. Angewandte Chemie International Edition 2012, 51 (24), 5798-5800.
Chayambuka, K.; Mulder, G.; Danilov, D. L.; Notten, P. H., From Li-Ion Batteries toward Na-Ion Chemistries: Challenges and Opportunities. Advanced Energy Materials 2020, 10 (38), 2001310.
Eftekhari, A., Lithium batteries for electric vehicles: from economy to research strategy. ACS Publications: 2019.
Liu, Y.; Zhu, Y.; Cui, Y., Challenges and opportunities towards fast-charging battery materials. Nature Energy 2019, 4 (7), 540-550.
Ahmed, S.; Bloom, I.; Jansen, A. N.; Tanim, T.; Dufek, E. J.; Pesaran, A.; Burnham, A.; Carlson, R. B.; Dias, F.; Hardy, K., Enabling fast charging-A battery technology gap assessment. Journal of Power Sources 2017, 367, 250-262.
Liu, Q.; Du, C.; Shen, B.; Zuo, P.; Cheng, X.; Ma, Y.; Yin, G.; Gao, Y., Understanding undesirable anode lithium plating issues in lithium-ion batteries. RSC advances 2016, 6 (91), 88683-88700.
Prezas, P. D.; Somerville, L.; Jennings, P.; McGordon, A.; Basco, J. K.; Duong, T.; Bloom, I. Effect of fast charging of lithium-ion cells: performance and post-test results; 0148-7191; SAE Technical Paper. 2016.
Yverick Rangom, T. T. D., X. S. Zhao, Lithium-Ion Transport Behavior in Thin-Film Graphite Electrodes with SEI Layers Formed at Different Current Densities. ACS Applied Materials & Interfaces 2021.

Yang, X.-G.; Zhang, G.; Ge, S.; Wang, C.-Y., Fast charging of lithium-ion batteries at all temperatures. Proceedings of the National Academy of Sciences 2018, 115 (28), 7266-7271.
Hou, J.; Yang, M.; Wang, D.; Zhang, J., Fundamentals and challenges of lithium ion batteries at temperatures between −40 and 60° C. Advanced Energy Materials 2020, 10 (18), 1904152.
Kang, B.; Ceder, G., Battery materials for ultrafast charging and discharging. Nature 2009, 458 (7235), 190-193
Kurmaev, E.; Morozova, O.; Khomenko, T.; Borchers, C.; Nemnonov, S.; Harada, Y.; Tokushima, T.; Osawa, H.; Takeuchi, T.; Shin, S., Local bonding structure in mechanically activated TiH₂ and TiH₂+graphite mixture. Journal of alloys and compounds 2005, 395 (1-2), 8 240-246.
Rangom, Y.; Gaddam, R. R.; Duignan, T. T.; Zhao, X., Improvement of hard carbon electrode performance by manipulating SEI formation at high charging rates. ACS applied materials & interfaces 2019, 11 (38), 34796-34804.
Rangom, Y.; Tang, X.; Nazar, L. F., Carbon nanotube-based supercapacitors with excellent ac line filtering and rate capability via improved interfacial impedance. ACS nano 2015, 9 (7), 7248-7255.
Yan, Z.; Obrovac, M. N. In Thermally Treated Sodium Carboxymethyl Cellulose Binder for Si Alloy Anodes, ECS Meeting Abstracts, IOP Publishing: 2018; p 254.
Nnakwo, K. C.; Mbah, C. N.; Nnuka, E. E., Influence of trace additions of titanium on grain characteristics, conductivity and mechanical properties of copper-silicon-titanium alloys. Heliyon 2019, 5 (10), e02471.
Zhang, H.; Liu, X.; Jiang, Y., Pore formation process of porous Ti3SIC2 fabricated by reactive sintering. Materials 2017, 10 (2), 163.
Lee, Y.-S.; Lee, J.-H.; Kim, Y.-W.; Sun, Y.-K.; Lee, S.-M., Rapidly solidified Ti—Si alloys/carbon composites as anode for Li-ion batteries. Electrochimica acta 2006, 52 (4), 1523-1526.

1. An electrode comprising:
a current collector; and
a layer, provided on the current collector, comprising conductive active material particles;
wherein:
at least some of the conductive active materials are covalently bound or alloyed to the current collector; and/or
at least some of the conductive active materials are covalently bound or alloyed to each other.

2. The electrode of claim 1, wherein the conductive active materials comprise:
carbonaceous materials, such as graphite, hard carbons, soft carbons, advanced carbon materials, such as carbon nanotubes, graphene, and fullerenes, activated carbons, carbon blacks, carbon papers, carbon fibers, carbon felts, or any mixture thereof;
carbon coated or carbon composited metalloids, su as carbon-coated lithium iron phosphate, carbon coated silicon, carbon coated silicon oxide, carbon coated germanium, carbon coated germanium oxide, carbon coated antimony, carbon coated antimony oxide, carbon coated tin, carbon coated tin oxide, carbon coated zinc, carbon coated zinc oxide, carbon coated sulfur, carbon coated sulfur oxide, or any mixture thereof;
metalloid materials, such as silicon, germanium, antimony, tin, zinc, sulfur, any compounds or oxides thereof, or any mixture thereof;
transition metal oxides, such as titanium oxide, manganese oxide, cobalt oxide, iron oxide, nickel oxide, or any mixture thereof;
transition metal carbides or nitrides, such as MXenes or selenides;
or combinations thereof.

3. (canceled)

4. (canceled)

5. (canceled)

6. (canceled)

7. (canceled)

8. (canceled)

9. The electrode of claim 1, wherein the covalent bond or alloy comprises a combination of particles of the conductive active material with particles of one or more carbide or alloy forming additives.

10. The electrode of claim 9, wherein the carbide or alloy forming additives comprise;
compounds of transition metal and metalloid elements;
compounds of titanium, vanadium, tungsten, zirconium, molybdenum, niobium, silicon, or germanium, and mixtures thereof, or
TiH₂.

11. (canceled)

12. (canceled)

13. The electrode of claim 1, wherein the current collector comprises graphite or a metal material, such as, copper, titanium-coated copper, or aluminum.

14. (canceled)

15. The electrode of claim 1, wherein the electrode is an anode or a cathode.

16. A battery comprising the electrode of claim 15.

17. The battery of claim 16, wherein the battery is a Li-ion battery or an alkali-ion battery.

18. A method of manufacturing an electrode, the method comprising:
a) mixing: i) conductive active materials in particulate form, and ii) one or more carbide or alloy forming additives in particulate form;
b) forming a dispersion of the mixture of a) in a solvent;
c) casting the dispersion to form a coating on a surface of a current collector; and
d) heating the coated current collector.

19. The method of claim 18, wherein the conductive active materials comprise:
carbonaceous materials, such as graphite, hard carbons, soft carbons, advanced carbon materials, such as carbon nanotubes, graphene, and fullerenes, activated carbons, carbon blacks, carbon papers, carbon fibers, carbon felts, or any mixture thereof;
carbon coated or carbon composited metalloids, such as carbon-coated lithium iron phosphate, carbon coated silicon, carbon coated silicon oxide, carbonated germanium, carbon coated germanium oxide, carbon coated antimony, carbon coated antimony oxide, carbon coated tin, carbon coated tin oxide, carbon coated zinc, carbon coated zinc oxide, carbon coated sulfur, carbon coated sulfur oxide, or any mixture thereof;
metalloid materials, such as silicon, germanium, antimony, tin, zinc, sulfur, any compounds or oxides thereof, or any mixture thereof;
transition metal oxides, such as titanium oxide, manganese oxide, cobalt oxide, iron oxide, nickel oxide, or any mixture thereof;
transition metal carbides or nitrides, such as MXenes or selenides;
or combinations thereof.

20. (canceled)

21. (canceled)

22. (canceled)

23. (canceled)

24. (canceled)

25. (canceled)

26. The method of claim 19, wherein the carbide or alloy forming additives comprise:
compounds of transition metal and metalloid elements;
compounds of titanium, vanadium, tungsten, zirconium, molybdenum, niobium, silicon, or germanium, and mixtures thereof; or
TiH₂.

27. (canceled)

28. (canceled)

29. The method of claim 18, wherein the current collector comprises:
graphite;
a metal, such as titanium, copper, titanium-coated copper or aluminum; or
a metalloid, such as silicon.

30. (canceled)

31. (canceled)

32. The method of any claim 18, wherein the solvent comprises polyacrylic acid and or polyvinyl alcohol.

33. The method of claim 32, wherein the solvent is dispersed in N-methyl-2-pyrrolidine.

34. The method of claim 18, wherein step b) further comprises homogenizing the dispersion.

35. The method of claim 18, wherein step c) further comprises drying the coated current collector.

36. The method of claim 18, wherein step d) comprises sintering at a temperature from about 400° C. to about 1000° C.

37. The method of claim 36, wherein step d) comprises sintering at a pressure of about 31 MPa.

38. The method of claim 37, wherein step d) comprises sintering in a noble gas atmosphere.

39. The method of claim 38, wherein the noble gas is argon.

40. The method of claim 18, wherein prior to step a), the one or more carbide or alloy forming additives are pre-treated by:
combining the additive particles with an amount of the active material particles; and,
ball milling the combination under inert atmosphere.

41. The method of claim 40, wherein the weight ratio of the additive particles to the amount of the active material particles is at least 2:1.

42. The method of claim 40, wherein, prior to the ball milling, the additive particles and the amount of active material particles are combined with particles of a further conductive carbon additive.

43. (canceled)

44. (canceled)

45. (canceled)

46. (canceled)
